(19) United States
(12) Patent Application Publication
(10) Pub. No.: US 2024/0250581 A1
(43) Pub. Date: Jul. 25, 2024

(54) BRIDGE DRIVE SYSTEM

(71) Applicant: Schaeffer Technologies AG & Co. KG, Herzogenaurach (DE)

(72) Inventors: Lei Liu, Shanghai (CN); Zhinqiang SONG, Shanghai (CN); Peng OUYANG, Shanghai (CN); Bo HUANG, Shanghai (CN)

(73) Assignee: Schaeffer Technologies AG & Co. KG, Herzogenaurach (DE)

(21) Appl. No.: 18/566,165

(22) PCT Filed: Jun. 1, 2021
(86) PCT No.: PCT/CN2021/097655

§ 371 Date: Dec. 1, 2023

(51) Int. Cl. H02K 9/19; F16H 57/04; H02K 1/32; H02K 7/116

(52) U.S. Cl. CPC H02K 9/19; F16H 57/043; H02K 1/32; H02K 7/116

(57) ABSTRACT

A bridge drive system, including a housing, a motor, a speed reduction mechanism, and a shaft assembly. The housing has first and second spaces separated from each other. The motor is in the first space, and the speed reduction mechanism is in the second space. The shaft assembly has an oil inlet and an oil outlet which are both located in the second space. An oil passage extending from the oil inlet into the first space and then returning to the oil outlet is formed inside the shaft assembly so that oil from the second space can flow from the oil inlet into the oil passage to cool a rotor and then return to the second space from the oil outlet. In this way, the cooling performance of a motor is improved, improving its performance and reducing heat resistance requirements of each component.

### CROSS-REFERENCE TO RELATED APPLICATIONS

This application is the U.S. National Phase of PCT Appln. No. PCT/CN2021/100143, filed Jun. 1, 2021, the entire disclosure of which is incorporated by reference herein.

### TECHNICAL FIELD

The present disclosure relates to the field of power systems of vehicles, and particularly relates to a bridge drive system for a vehicle.

### BACKGROUND

In a pure electric vehicle, a motor is used as a power source, and a so-called bridge drive system is composed of the motor and a speed reduction mechanism. As shown in FIG. 1, in the design of an existing bridge drive system, a shaft of a motor 10 and an input shaft of a speed reduction mechanism 20 are integrated to form a rotating shaft 30. In order to reduce the weight of the above rotating shaft 30, the rotating shaft 30 is provided with blind holes on both a motor side and a speed reduction mechanism side. A partition wall 30w is formed between the two blind holes, so that oil stored in a housing corresponding to the speed reduction mechanism 20 cannot flow to a position where a rotor of the motor 10 is located via the rotating shaft 30.

Therefore, the motor 10 can only be cooled through a cooling jacket and air, resulting in poor cooling performance, which limits the performance of the motor 10 and requires the improvement of heat resistance requirements of each component. Because an inner diameter of the blind hole which is located on the side where the speed reduction mechanism 20 is located in the rotating shaft 30 is smaller than an inner diameter of the blind hole which is located on the side where the motor 10 is located in the rotating shaft 30, if the partition wall 30w is moved towards the side where the motor 10 is located to enable the oil stored in the housing corresponding to the speed reduction mechanism to flow to the position where the rotor of the motor 10 is located via the rotating shaft 30, this will cause a wall of the portion, located on the side where the motor 10 is located, of the rotating shaft 30 to be too thick.

### SUMMARY

The present disclosure has been made in view of the deficiencies of the prior art as described above. One object of the present disclosure is to provide a novel bridge drive system. The bridge drive system can transport oil stored in a housing corresponding to a speed reduction mechanism to a position where a rotor of a motor is located, thereby improving the cooling performance of the motor.

To achieve the above objects, the following technical solutions are adopted.

The present disclosure provides a bridge drive system which comprises a housing, a motor, a speed reduction mechanism, and a shaft assembly, wherein the housing comprises a first space and a second space separated from each other; the second space is located on one axial side relative to the first space in an axial direction of the shaft assembly; the motor is accommodated in the first space, and the speed reduction mechanism is accommodated in the second space; the shaft assembly comprises a shaft extending from the first space into the second space; the shaft is torsionally connected to a rotor of the motor, and the shaft is also used as an input shaft of the speed reduction mechanism;
the shaft assembly is formed with an oil inlet and an oil outlet which are both located in the second space; and an oil passage extending from the oil inlet into the first space and then returning to the oil outlet is formed inside the shaft assembly, so that oil from the second space can flow from the oil inlet into the oil passage to cool the rotor and then return to the second space from the oil outlet.

Preferably, an inner cavity running through the shaft along the axial direction is formed inside the shaft, and the shaft assembly further comprises:
an oil collecting component, wherein the oil collecting component is fixed to the housing and the oil collecting component and the shaft are spaced apart from each other, the oil inlet is formed on the oil collecting component, a portion, inserted into the inner cavity, of the oil collecting component is formed with a first oil inlet passage that is in communication with the oil inlet, and the oil collecting component can collect the oil in the second space into the first oil inlet passage via the oil inlet; and
an oil guide component, wherein the oil guide component is fixed to the shaft and is integrally located in the inner cavity, a second oil inlet passage in conduction with the first oil inlet passage is formed inside the oil guide component, an oil discharge passage is formed between the oil guide component and the shaft, the oil discharge passage is in communication with the second oil inlet passage and the oil outlet formed on the shaft, and during the rotation with the shaft, the oil guide component can enable the oil from the first oil inlet passage to sequentially flow through the second oil inlet passage and the oil discharge passage and then return to the second space from the oil outlet.

More preferably, the oil collecting component comprises:
an oil collecting cylinder portion, wherein the oil collecting cylinder portion is located in the inner cavity, the oil inlet is formed on one axial side end of the oil collecting cylinder portion, and the first oil inlet passage runs through the oil collecting cylinder portion along the axial direction; and
a flange portion, wherein the flange portion is located outside the shaft, the flange portion extends from one axial side end of the oil collecting cylinder portion towards a radial outer side, and at least a portion of the flange portion extends towards the radial outer side and obliquely extends towards the other axial side at the same time so as to cause the oil in the second space to converge at the oil inlet.

More preferably, a cross-sectional area of an inner cavity, used for forming the first oil inlet passage, of the oil collecting cylinder portion gradually increases from one axial side towards the other axial side.

More preferably, the oil collecting component further comprises a stop portion protruding from an outer circumference of the flange portion towards the radial outer side, and the stop portion is connected to the housing in a clamped manner.

More preferably, the oil guide component comprises:
an oil guide cylinder portion, wherein the oil guide cylinder portion is spaced apart from an inner wall of the shaft, and the second oil inlet passage runs through the oil guide cylinder portion along the axial direction;
a first end edge portion, wherein the first end edge portion is located on one axial side end of the oil guide cylinder portion and is fixed to the shaft; and
a second end edge portion, wherein the second end edge portion is located on the other axial side end of the oil guide cylinder portion and is fixed to the shaft, and the second end edge portion is formed with a communication port enabling communication between the second oil inlet passage and the oil discharge passage.

More preferably, a cross-sectional area of an inner cavity, used for forming the second oil inlet passage, of the oil guide cylinder portion gradually increases from one axial side towards the other axial side.

More preferably, an inner wall of the oil guide cylinder portion is formed with blades protruding towards the inside of the second oil inlet passage so as to guide the oil to flow in the oil passage during the rotation of the oil guide component with the shaft.

More preferably, the shaft assembly further comprises an oil plug located in the inner cavity of the shaft and fixed inside the shaft;
the inner cavity comprises a large diameter portion and a small diameter portion which are in communication to each other, a diameter of the large diameter portion is greater than a diameter of the small diameter portion, and the small diameter portion is located on one axial side relative to the large diameter portion, so that a step structure is formed inside the shaft; and
the oil guide component is located between the oil plug and the step structure, one axial side end of the oil guide component abuts against the step structure, and the other axial side end of the oil guide component abuts against the oil plug.

More preferably, the second end edge portion of the oil guide component is formed with a notch portion opened towards the oil plug, and the second end edge portion abuts against the oil plug, so that the notch portion forms a communication port enabling communication between the second oil inlet passage and the oil discharge passage.

By adopting the above technical solution, the present disclosure provides a novel bridge drive system. The bridge drive system comprises a housing, a motor, a speed reduction mechanism, and a shaft assembly. The housing comprises a first space and a second space separated from each other. The motor is accommodated in the first space, and the speed reduction mechanism is accommodated in the second space. The shaft assembly comprises a shaft extending from the first space into the second space. The shaft assembly is formed with an oil inlet and an oil outlet which are both located in the second space, and an oil passage extending from the oil inlet into the first space and then returning to the oil outlet is formed inside the shaft assembly, so that the oil from the second space can flow from the oil inlet into the oil passage to cool a rotor and then return to the second space from the oil outlet.

As a result, the shaft assembly is formed with a cooling mechanism for transporting the oil stored in the speed reduction mechanism to a position where the rotor of the motor is located. In this way, the cooling performance of the motor is improved, thereby improving the performance of the motor and reducing heat resistance requirements of each component.

### BRIEF DESCRIPTION OF THE DRAWINGS

FIG. 1 shows a cross-sectional schematic view of an existing bridge drive system.

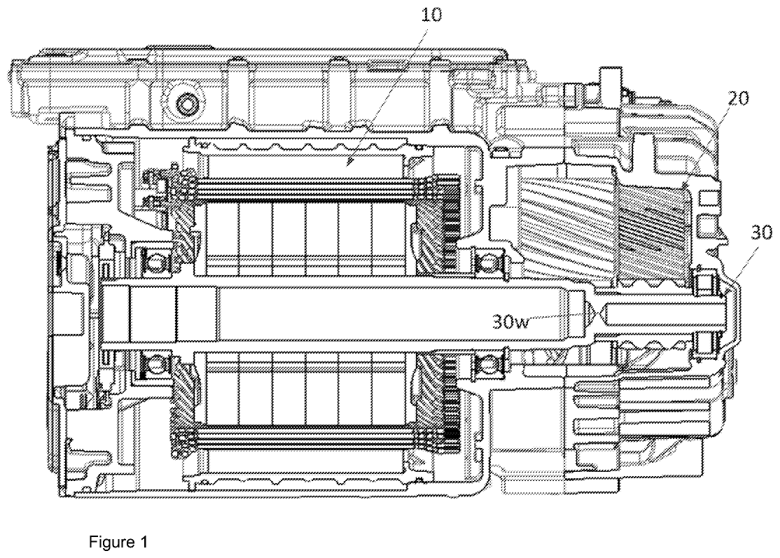

FIG. 2 shows a cross-sectional schematic view of a bridge drive system according to an embodiment of the present disclosure.

FIG. 3 shows a partially enlarged schematic view of the bridge drive system in FIG. 2.

FIG. 4 shows a three-dimensional schematic view of an oil collecting component of the bridge drive system in FIG. 2.

FIG. 5A shows a three-dimensional schematic view of an oil guide component of the bridge drive system in FIG. 2.

FIG. 5B shows another three-dimensional schematic view of the oil guide component of the bridge drive system in FIG. 2.

### DETAILED DESCRIPTION

Exemplary embodiments according to the present disclosure will be described below with reference to the attached drawings. It should be understood that these specific descriptions are only used to teach those skilled in the art how to implement the present disclosure, and are neither intended to be exhaustive of all possible variations of the present disclosure nor to limit the scope of the present disclosure.

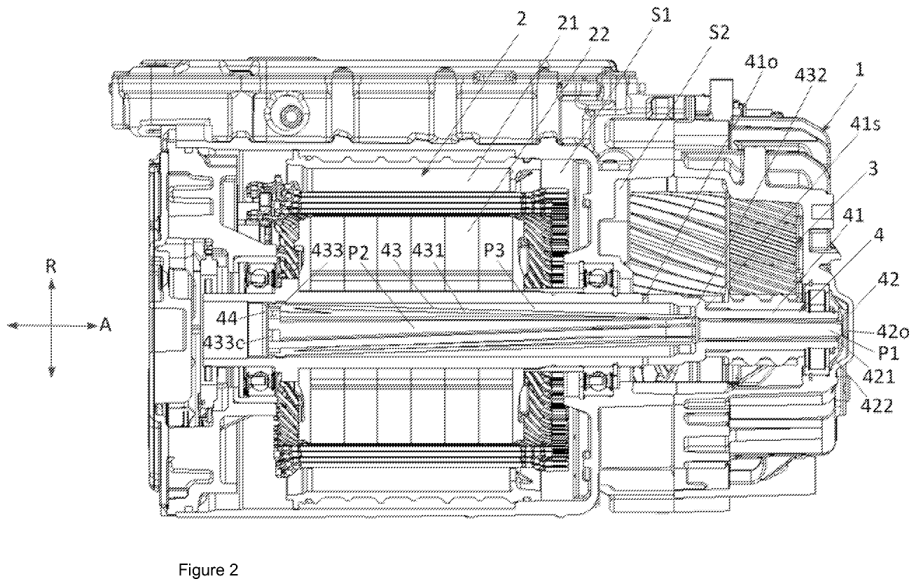

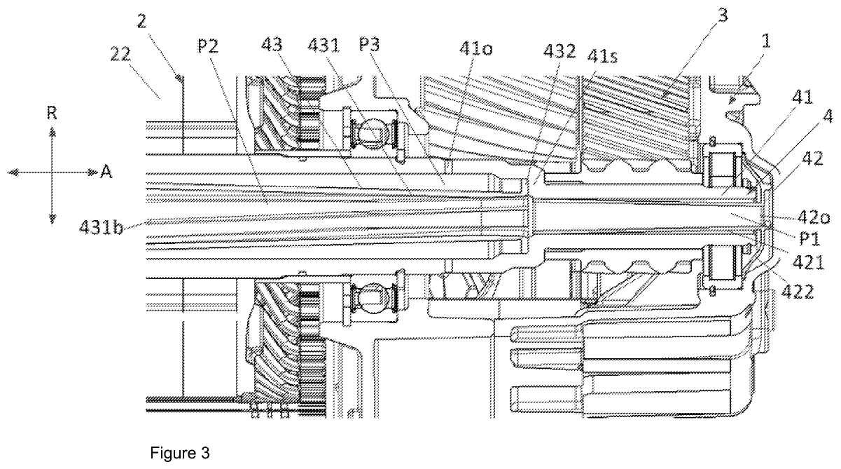

In the present disclosure, unless otherwise specified, “axial direction”, “radial direction” and “circumferential direction” refer to the axial direction, radial direction and circumferential direction of the shaft in the shaft assembly, respectively; “one axial side” refers to the right side in FIG. 2 and FIG. 3, and “the other axial side” refers to the left side in FIG. 2 and FIG. 3; and “radial outer side” refers to the side away from a central axis of the shaft in the radial direction, and “radial inner side” refers to the side close to the central axis of the shaft in the radial direction.

A structure of a bridge drive system according to an embodiment of the present disclosure will be described with reference to the attached drawings of the specification.

As shown in FIG. 2 and FIG. 3, the bridge drive system according to the embodiment of the present disclosure comprises a housing 1, a motor 2, a speed reduction mechanism 3, and a shaft assembly 4 which are assembled together. A mounting space is formed inside the housing 1, and the motor 2, the speed reduction mechanism 3 and the shaft assembly 4 are all located in the mounting space.

In the present embodiment, the housing 1 comprises a first space S1 and a second space S2 separated from each other. The first space S1 and the second space S2 are arranged in an axial direction A, and the second space S2 is located on one axial side relative to the first space S1. The motor 2 is accommodated in the first space S1, and the speed reduction mechanism 3 is accommodated in the second space S2.

In the present embodiment, the motor 2 comprises a stator 21 fixed relative to the housing 1 and a rotor 22 capable of rotating relative to the stator 21. The rotor 22 is located on a radial inner side of the stator 21 and is torsionally connected to a shaft 41 of the shaft assembly 4, so that the shaft 41 can rotate together with the rotor 22, thereby outputting a torque.

In the present embodiment, the speed reduction mechanism 3 comprises a transmission mechanism composed of a plurality of gears, and the shaft 41 of the shaft assembly 4 is also used as an input shaft of the speed reduction mechanism 3 to transfer the torque from the rotor 22 of the motor 2 to the speed reduction mechanism 3.

In the present embodiment, the shaft assembly 4 not only comprises the shaft 41 extending from the first space S1 into the second space S2, but also comprises an oil collecting component 42, an oil guide component 43 and an oil plug 44. Through these constituent components, the shaft assembly 4 is formed with an oil inlet 42o and an oil outlet 41o which are both located in the second space S2, and an oil passage extending from the oil inlet 42o into the first space S1 and then returning to the oil outlet 41o is formed inside the shaft assembly 4, so that the shaft assembly 4 forms a cooling mechanism enabling the oil in the second space S2 to flow from the oil inlet 42o into the oil passage to cool the rotor 22 and then return to the second space S2 from the oil outlet 41o.

As mentioned above, in the present embodiment, on one hand, the shaft 41 is torsionally connected to the rotor 22 of the motor 2, and on the other hand, the shaft 41 is used as the input shaft 41 of the speed reduction mechanism 3. In this way, the torque from the rotor 22 of the motor 2 can be transferred to the speed reduction mechanism 3 via the shaft 41.

An inner cavity running through the entire shaft 41 along the axial direction A is formed inside the shaft 41. The inner cavity comprises a large diameter portion and a small diameter portion which are in communication to each other, a diameter of the large diameter portion is greater than a diameter of the small diameter portion, and the small diameter portion is located on one axial side relative to the large diameter portion, so that a step structure 41s is formed at a portion, located in the second space S2, of the shaft 41. In this way, compared with a rotating shaft 30 described in the background art, the thickness of a wall, located on the other axial side of the step structure 41s, of the shaft 41 is not increased.

In addition, a portion, located in the second space S2, of the shaft 41 is also formed with a plurality of oil outlets 41o running through the shaft 41 in a radial direction R, and the second space S2 is in communication with the large diameter portion of the inner cavity of the shaft 41 via the plurality of oil outlets 41o.

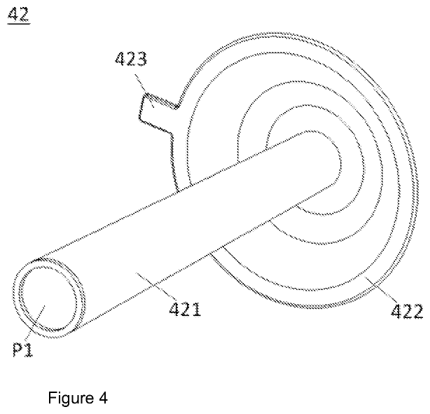

In the present embodiment, a portion of the oil collecting component 42 is inserted into the inner cavity of the shaft 41, and the other portion of the oil collecting component 42 is located between the shaft 41 and the housing 1. The oil collecting component 42 is fixed to the housing 1, and the oil collecting component 42 and the shaft 41 are spaced apart from each other. The oil collecting component 42 is used for collecting the oil thrown out by the gears of the speed reduction mechanism 3. As shown in FIG. 4, the oil collecting component 42 comprises an oil collecting cylinder portion 421, a flange portion 422 and a stop portion 423 which are integrated.

The oil collecting cylinder portion 421 has a cylinder shape. The oil collecting cylinder portion 421 is inserted into the small diameter portion of the inner cavity of the shaft 41, the oil collecting cylinder portion 421 is spaced apart from the shaft 41 in the radial direction R, and an axial size of the oil collecting cylinder portion 421 is roughly the same as an axial size of the small diameter portion of the inner cavity of the shaft 41. The oil inlet 42o of the above cooling mechanism is formed on one axial side end of the oil collecting cylinder portion 421, and is always opened towards the second space S2. A first oil inlet passage P1 running through the oil collecting cylinder portion 421 along the axial direction A is formed inside the oil collecting cylinder portion 421. In this way, the first oil inlet passage P1 is in communication with the second space S2 via the oil inlet 42o. In addition, the cross-sectional area of the first oil inlet passage P1 gradually increases from one axial side towards the other axial side, thereby preventing the oil in the first oil inlet passage P1 from returning to the oil inlet 42o.

The flange portion 422 has a disc shape and is located outside the shaft 41. The flange portion 422 extends from one axial side end of the oil collecting cylinder portion 421 towards the radial outer side, and a portion of the radial outer side of the flange portion 422 extends towards the radial outer side and obliquely extends towards the other axial side at the same time. In this way, in cooperation with the structure, used for guiding oil, of the inner wall of the housing 1, the flange portion 422 can cause the oil in the second space S2 to converge at the oil inlet 42o, so that the oil collecting component 42 can collect the oil in the second space S2 into the first oil inlet passage P1 via the oil inlet 42o.

The stop portion 423 protrudes a certain length from an outer circumference of the flange portion 422 towards the radial outer side, and the stop portion 423 is connected to the housing 1 in a clamped manner, so that the oil collecting component 42 is fixed relative to the housing 1.

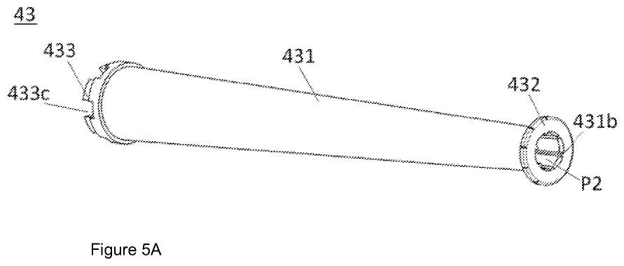

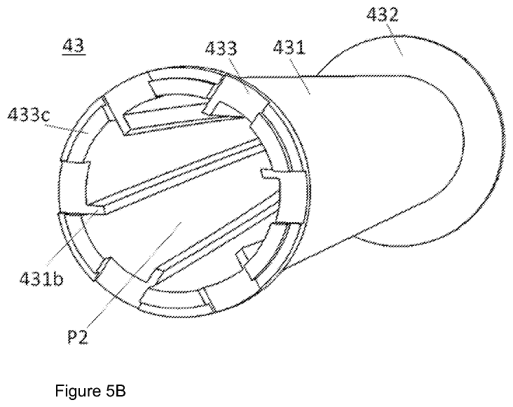

In the present embodiment, the oil guide component 43 is fixed to the shaft 41 and is integrally located in the large diameter portion of the inner cavity of the shaft 41. As shown in FIG. 5A and FIG. 5B, the oil guide component 43 integrally has a cylinder shape. The oil guide component 43 comprises an oil guide cylinder portion 431, a first end edge portion 432, and a second end edge portion 433 which are integrated.

The oil guide cylinder portion 431 is spaced apart from an inner wall of the shaft 41 in the radial direction R. A second oil inlet passage P2 in communication with the first oil inlet passage P1 is formed inside the oil guide component 431, and the second oil inlet passage P2 runs through the oil guide cylinder portion 431 along the axial direction A. The cross-sectional area of an inner cavity of the second oil inlet passage P2 gradually increases from one axial side towards the other axial side, thereby preventing the oil entering the second oil inlet passage P2 from returning to the first oil inlet passage P1 on one hand, and being beneficial for guiding the oil in the second oil inlet passage P2 from one axial side towards the other axial side during the rotation of the oil guide component 43 with the shaft 41 on the other hand. An oil discharge passage P3 is formed between an outer wall of the oil guide cylinder portion 431 and the inner wall of the shaft 41, and the oil discharge passage P3 is in communication with the second oil inlet passage P2 and the oil outlet 41o formed on the shaft 41. In addition, the inner wall of the oil guide cylinder portion 431 is formed with blades 431b protruding towards the inside of the second oil inlet passage P2, and these blades 431b spirally extend along the axial direction A. In this way, during the rotation of the oil guide component 43 with the shaft 41, a negative pressure can be formed in the second oil inlet passage P2, thereby being beneficial for the oil in the first oil inlet passage P1 to enter the second oil inlet passage P2 towards the other axial side and further flow towards the other axial side. This is beneficial for accelerating the circulation of the oil in the oil passage of the cooling mechanism.

The first end edge portion 432 is located on one axial side end of the oil guide cylinder portion 431 and extends from the oil guide cylinder portion 431 towards the radial outer side. The first end edge portion 432 is fixed together with the shaft 41 through an interference fit, and the first end edge portion 432 abuts against the step structure 41s of the shaft 41 from the other axial side.

The second end edge portion 433 is located on the other axial side end of the oil guide cylinder portion 431 and extends from the oil guide cylinder portion 431 towards the radial outer side. The second end edge portion 433 is in interference fit with the shaft 41 and is fixed to the shaft 41, and the second end edge portion 433 abuts against the oil plug 44 from one axial side. The second end edge portion 433 of the oil guide component 43 is formed with a notch portion 433c opened towards the oil plug 44, and the notch portion 433c forms a communication port enabling communication between the second oil inlet passage P2 and the oil discharge passage P3.

In the present embodiment, the oil plug 44 is located in the large diameter portion of the inner cavity of the shaft 41 and is fixed to the shaft 41 through an interference fit, the oil guide component 43 is located between the oil plug 44 and the step structure 41s, one axial side end of the oil guide component 43 abuts against the step structure 41s, and the other axial side end of the oil guide component 43 abuts against the oil plug 44.

The working process of the cooling mechanism of the bridge drive system according to the present disclosure is described below.

When the motor 2 is in a working state, the rotor 22 of the motor 2 drives the shaft 41 to rotate, and the shaft 41 drives the gears of the speed reduction mechanism 3 to rotate. During the rotation of the gears, the oil in the second space S2 is thrown to the inner wall of the housing 1.

Further, through the oil collecting structure on the inner wall of the housing 1 and the oil collecting component 42 of the shaft assembly 4, the oil on the inner wall of the housing 1 is collected to the oil inlet 42o and enters the first oil inlet passage P1 of the oil collecting component 42.

Further, because the negative pressure is formed in the second oil inlet passage P2 during the rotation of the oil guide component 43 with the shaft 41, the negative pressure is increased through the blades 431b of the oil guide component 43, and the oil in the first oil inlet passage P1 of the oil collecting component 42 flows into the second oil inlet passage P2 of the oil guide component 43 and continuously flows towards the other axial side.

Further, via the communication port of the oil guide component 43, the oil in the second oil inlet passage P2 of the oil guide component 43 flows into the oil discharge passage P3 between the outer wall of the oil guide component 43 and the inner wall of the shaft 41, and the oil in the oil discharge passage P3 cools the rotor 22 of the motor 2 and flows towards one axial side.

Finally, the oil in the oil discharge passage P3 returns to the inside of the second space S2 via the oil outlet 41o, thereby completing the circulation process.

When the bridge drive system is in the working state, the above circulation process is continuously performed, thereby using the oil in the second space S2 for continuously cooling the rotor 22 of the motor 2, and further improving the cooling performance of the motor 2.

The present disclosure is not limited to the above embodiments. Under the guidance of the present disclosure, those skilled in the art can make various modifications to the above embodiments of the present disclosure without departing from the scope of the present disclosure. In addition, it should also be noted that:
(i) Although there is no specific explanation in the above specific embodiments, it can be understood that if considering from the perspective of no cost increase, the cross section of the large diameter portion of the inner cavity of the shaft 41 may be the same in the axial direction A; and if considering from the perspective of facilitating the flow of oil in the oil discharge passage P3 towards the oil outlet 41o during the rotation of the shaft 41, the cross section of the large diameter portion may also gradually increase towards the oil outlet 41o.
(ii) Although there is no specific explanation in the above specific embodiments, it can be understood that in the mounting process of inserting the oil collecting component 42 and the oil guide component 43 into the inner cavity of the shaft 41, the oil collecting component 42 is inserted into the small diameter portion of the inner cavity of the shaft 41 from one axial side, and the oil guide component 43 is inserted into the large diameter portion of the inner cavity of the shaft 41 from the other axial side.
(iii) Although there is no specific explanation in the above specific embodiments, it can be understood that the shape of the first oil inlet passage P1 and the second oil inlet passage P2 may be a circular truncated cone shape with a cross-sectional area gradually increasing from one axial side towards the other axial side. Preferably, both the first oil inlet passage P1 and the second oil inlet passage P2 are formed with a cone angle. The cone angle of the first oil inlet passage P1 enables the first oil inlet passage P1 to expand towards the other axial side, and the cone angle of the second oil inlet passage P2 enables the second oil inlet passage P2 to expand towards the other axial side.
(iv) The bridge drive system of the present disclosure is not limited to pure electric vehicles, but may also serve as a portion of a hybrid power system to be used for hybrid power vehicles.

### LIST OF REFERENCE NUMERALS

10 Motor
20 Speed reduction mechanism
30 Rotating shaft
30w Partition wall
1 Housing
S1 First space
S2 Second space
2 Motor
21 Stator
22 Rotor
3 Speed reduction mechanism
4 Shaft assembly
41 Shaft
41o Oil outlet
41s Step structure
42 Oil collecting component
42o Oil inlet
421 Oil collecting cylinder portion
422 Flange portion
423 Stop portion
43 Oil guide component
431 Oil guide cylinder portion
431b Blade
432 First end edge portion
433 Second end edge portion
433c Notch portion
44 Oil plug
P1 First oil inlet passage
P2 Second oil inlet passage
P3 Oil discharge passage
A Axial direction
R Radial direction.

1. A bridge drive system, comprising:
a housing;
a motor;
a speed reduction mechanism;
a shaft assembly;
the housing comprises a first space and a second space separated from each other, the second space is located on one axial side relative to the first space in an axial direction of the shaft assembly, the motor is accommodated in the first space, and the speed reduction mechanism is accommodated in the second space (S2));
the shaft assembly comprises a shaft extending from the first space into the second space, the shaft is torsionally connected to a rotor of the motor, and the shaft is used as an input shaft of the speed reduction mechanism, the shaft assembly is formed with an oil inlet and an oil outlet which are both located in the second space; and
an oil passage extending from the oil inlet into the first space and then returning to the oil outlet is formed inside the shaft assembly, so that oil from the second space can flow from the oil inlet into the oil passage to cool the rotor and then return to the second space from the oil outlet.

2. The bridge drive system according to claim 1, wherein an inner cavity running through the shaft along the axial direction is formed inside the shaft, and the shaft assembly further comprises:
an oil collecting component fixed to the housing, the oil collecting component and the shaft are spaced apart from each other, the oil inlet is formed on the oil collecting component, a portion of the oil collecting component which is inserted into the inner cavity is formed with a first oil inlet passage that is in communication with the oil inlet, and the oil collecting component is adapted to collect the oil in the second space into the first oil inlet passage via the oil inlet; and
an oil guide component fixed to the shaft and integrally located in the inner cavity, a second oil inlet passage in conduction with the first oil inlet passage is formed inside the oil guide component, an oil discharge passage is formed between the oil guide component and the shaft, the oil discharge passage is in communication with the second oil inlet passage and the oil outlet formed on the shaft, and during rotation with the shaft, the oil guide component is adapted to enable the oil from the first oil inlet passage to sequentially flow through the second oil inlet passage and the oil discharge passage and then return to the second space from the oil outlet.

3. The bridge drive system according to claim 2, wherein the oil collecting component comprises:
an oil collecting cylinder portion located in the inner cavity, the oil inlet is formed on one axial side end of the oil collecting cylinder portion, and the first oil inlet passage runs through the oil collecting cylinder portion along the axial direction; and
a flange portion located outside the shaft, the flange portion extends from the one axial side end of the oil collecting cylinder portion towards a radial outer side, and at least a portion of the flange portion extends towards the radial outer side and obliquely extends towards the other axial side at the same time to cause the oil in the second space to converge at the oil inlet.

4. The bridge drive system according to claim 3, wherein a cross-sectional area of an inner cavity, used for forming the first oil inlet passage, of the oil collecting cylinder portion increases from the one axial side towards the other axial side.

5. The bridge drive system according to claim 3, wherein the oil collecting component further comprises a stop portion protruding from an outer circumference of the flange portion towards the radial outer side, and the stop portion is connected to the housing in by clamping.

6. The bridge drive system according to claim 2, wherein the oil guide component comprises:
an oil guide cylinder portion spaced apart from an inner wall of the shaft, and the second oil inlet passage runs through the oil guide cylinder portion along the axial direction;
a first end edge portion located on one axial side end of the oil guide cylinder portion and fixed to the shaft; and
a second end edge portion located on the other axial side end of the oil guide cylinder portion and fixed to the shaft, and the second end edge portion is formed with a communication port enabling communication between the second oil inlet passage and the oil discharge passage.

7. The bridge drive system according to claim 6, wherein a cross-sectional area of an inner cavity, used for forming the second oil inlet passage, of the oil guide cylinder portion increases from one axial side towards the other axial side.

8. The bridge drive system according to claim 6, wherein an inner wall of the oil guide cylinder portion is formed with blades protruding towards an inside of the second oil inlet passage so as to guide the oil to flow in the oil passage during rotation of the oil guide component with the shaft.

9. The bridge drive system according to claim 2, wherein the shaft assembly further comprises an oil plug located in the inner cavity of the shaft and fixed inside the shaft;
the inner cavity comprises a large diameter portion and a small diameter portion which are in communication with each other, a diameter of the large diameter portion is greater than a diameter of the small diameter portion, and the small diameter portion is located on one axial side relative to the large diameter portion, so that a step structure is formed inside the shaft; and
the oil guide component is located between the oil plug and the step structure, one axial side end of the oil guide component abuts against the step structure, and the other axial side end of the oil guide component abuts against the oil plug.

10. The bridge drive system according to claim 9, wherein the second end edge portion of the oil guide component is formed with a notch portion opened towards the oil plug, and the second end edge portion abuts against the oil plug so that the notch portion forms a communication port enabling communication between the second oil inlet passage and the oil discharge passage.

11. A bridge drive system, comprising:
a housing;
a motor;
a gear assembly;
a shaft assembly;
the housing comprises a first space and a second space separated from each other, the second space is located on one axial side relative to the first space in an axial direction of the shaft assembly, the motor is located in the first space, and the gear assembly is located in the second space;
the shaft assembly comprises a shaft extending from the first space into the second space, the shaft is connected to a rotor of the motor, and the shaft forms an input shaft of the speed gear assembly, the shaft assembly includes an oil inlet and an oil outlet which are both located in the second space; and
an oil passage extends from the oil inlet into the first space and then returns to the oil outlet formed inside the shaft assembly, so that oil from the second space flows from the oil inlet into the oil passage to cool the rotor and then return to the second space from the oil outlet.

12. The bridge drive system according to claim 11, wherein an inner cavity running through the shaft along the axial direction is formed inside the shaft, and the shaft assembly further comprises:
an oil collecting component fixed to the housing, the oil collecting component and the shaft are spaced apart from each other, the oil inlet is formed on the oil collecting component, a portion of the oil collecting component which is inserted into the inner cavity is formed with a first oil inlet passage that is in communication with the oil inlet, and the oil collecting component is adapted to collect the oil in the second space into the first oil inlet passage via the oil inlet; and
an oil guide component fixed to the shaft and integrally located in the inner cavity, a second oil inlet passage in conduction with the first oil inlet passage is formed inside the oil guide component, an oil discharge passage is formed between the oil guide component and the shaft, the oil discharge passage is in communication with the second oil inlet passage and the oil outlet formed on the shaft, and during rotation with the shaft, the oil guide component is adapted to enable the oil from the first oil inlet passage to sequentially flow through the second oil inlet passage and the oil discharge passage and then return to the second space from the oil outlet.

13. The bridge drive system according to claim 12, wherein the oil collecting component comprises:
an oil collecting cylinder portion located in the inner cavity, the oil inlet is formed on one axial side end of the oil collecting cylinder portion, and the first oil inlet passage runs through the oil collecting cylinder portion along the axial direction; and
a flange portion located outside the shaft, the flange portion extends from the one axial side end of the oil collecting cylinder portion towards a radial outer side, and at least a portion of the flange portion extends towards the radial outer side and obliquely extends towards the other axial side at the same time to cause the oil in the second space to converge at the oil inlet.

14. The bridge drive system according to claim 13, wherein a cross-sectional area of an inner cavity, used for forming the first oil inlet passage, of the oil collecting cylinder portion increases from the one axial side towards the other axial side.

15. The bridge drive system according to claim 13, wherein the oil collecting component further comprises a stop portion protruding from an outer circumference of the flange portion towards the radial outer side, and the stop portion is connected to the housing in by clamping.

16. The bridge drive system according to claim 12, wherein the oil guide component comprises:
an oil guide cylinder portion spaced apart from an inner wall of the shaft, and the second oil inlet passage runs through the oil guide cylinder portion along the axial direction;
a first end edge portion located on one axial side end of the oil guide cylinder portion and fixed to the shaft; and
a second end edge portion located on the other axial side end of the oil guide cylinder portion and fixed to the shaft, and the second end edge portion is formed with a communication port enabling communication between the second oil inlet passage and the oil discharge passage.

17. The bridge drive system according to claim 16, wherein a cross-sectional area of an inner cavity, used for forming the second oil inlet passage, of the oil guide cylinder portion increases from one axial side towards the other axial side.

18. The bridge drive system according to claim 16, wherein an inner wall of the oil guide cylinder portion is formed with blades protruding towards an inside of the second oil inlet passage so as to guide the oil to flow in the oil passage during rotation of the oil guide component with the shaft.

19. The bridge drive system according to claim 12, wherein the shaft assembly further comprises an oil plug located in the inner cavity of the shaft and fixed inside the shaft;
the inner cavity comprises a large diameter portion and a small diameter portion which are in communication with each other, a diameter of the large diameter portion is greater than a diameter of the small diameter portion, and the small diameter portion is located on one axial side relative to the large diameter portion, so that a step structure is formed inside the shaft; and
the oil guide component is located between the oil plug and the step structure, one axial side end of the oil guide component abuts against the step structure, and the other axial side end of the oil guide component abuts against the oil plug.

20. The bridge drive system according to claim 19, wherein the second end edge portion of the oil guide component is formed with a notch portion opened towards the oil plug, and the second end edge portion abuts against the oil plug so that the notch portion forms a communication port enabling communication between the second oil inlet passage and the oil discharge passage.
